(19) United States
(12) Patent Application Publication
(10) Pub. No.: US 2003/0070830 A1
(43) Pub. Date: Apr. 17, 2003

(54) Wire harness and vehicle module assembly incorporating the same

(75) Inventors: Masayuki Kondo, Toyota-shi (JP); Haruhiko Sato, Toyota-shi (JP)

Correspondence Address: SUGHRUE MION, PLLC, 2100 PENNSYLVANIA AVENUE, N.W., WASHINGTON, DC, 20037, US

(73) Assignee: YAZAKI CORPORATION

(21) Appl. No.: 10/265,706

(22) Filed: Oct. 8, 2002

(30) Foreign Application Priority Data
Oct. 15, 2001 (JP) P2001-316799

(51) Int. Cl. H01B 1/00

(52) U.S. Cl. 174/68.1

(57) ABSTRACT

In a first flat harness, a plurality of first conductive wires are covered with a first insulating cover. In a second flat harness, a plurality of second conductive wires are covered with a second insulating cover. The second flat harness is intersectingly superposed on the first flat harness. Each second conductive wire is welded to one of the first conductive wires at one of intersecting points of each second conductive wire and the first conductive wires, through the first insulating cover and the second insulating cover.

### BACKGROUND OF THE INVENTION

This invention relates to a wire harness and a vehicle module assembly incorporating the same.

As a first related-art, a wiring circuitry disclosed in Japanese Patent Publication No. 9-29445A will be described with reference to FIGS. 9A and 9B.

This wiring circuitry 100 is manufactured in the following manner. First, conductors (round wires) 120 are respectively positioned and held in receiving grooves 112 formed in an upper face 111 of a fixing jig 110 in a lattice-like pattern. Through holes 140 are formed at each intersection of the receiving grooves 112. Next, a pair of tips 130 of a resistance welding machine or an ultrasonic welding machine are inserted into each through hole 140 are inserted into each through hole 140 respectively from the upper and lower sides of the fixing jig 110 such that the conductors 120 are press-joined together.

Since the conductors 120 are prevented from being displaced out of position, the intersecting conductors 120 can be welded together with accuracy.

However, the conductors 120 must be mounted one by one in the respective receiving grooves 112, and this is cumbersome.

As a second related-art, an installing structure for a wire harness used in a reinforce of a vehicle module assembly will be described with reference to FIG. 10.

A wire harness 220 comprises a main wire portion 220a, and a branch wire portion 220b branching off therefrom. The main wire portion 220a is mounted on a side wall of a reinforce 210 of a vehicle module assembly 200. The branch wire portion 220b is connected to a branch portion of the main wire portion 220a by a connector 230. A connector 240 for connection to an electrical equipment is mounted on the other or distal end of the branch wire portion 220b.

In this configuration, since the electrical connection at each branch portion and the electrical connection to the electrical equipment can be all effected through the connectors 230 and 240, required time for the installing operation can be reduced, and besides the reliability of the wiring can be enhanced.

However, in this configuration, since an interruption is provided not only between the main wire portion 220a and the branch wire portion 220b, but also in the main wire portion 220a because of the provision of the connector 230 through which the main wire portion 220a is connected to the branch wire portion 220b. Therefore, it is necessary to provide a separate connector even in the main wire portion 220a.

Furthermore, in the case where the main wire or the branch wire comprises many conductors twisted together, a meticulous attention is needed when connecting the conductors respectively to predetermined connector terminals. Hence, there is a probability that increased time is required for mounting the connector.

### SUMMARY OF THE INVENTION

It is therefore an object of the present invention to provide a wiring circuitry which can be easily manufactured and can provide the wiring having a reduced number of connectors.

It is another object of the present invention to provide a wire harness using the wiring circuitry and a vehicle module assembly incorporating the wire harness, which can reduce wiring labor, wiring length, installation spaces in the vehicle.

In order to achieve the above objects, according to the present invention, there is provided a wire harness, comprising:

a first flat harness, in which a plurality of first conductive wires are covered with a first insulating cover; and

a second flat harness, in which a plurality of second conductive wires are covered with a second insulating cover, the second flat harness being intersectingly superposed on the first flat harness,

wherein each second conductive wire is welded to one of the first conductive wires at one of intersecting points of each second conductive wire and the first conductive wires, through the first insulating cover and the second insulating cover.

According to the present invention, there is also provided a wire harness, comprising:

a plurality of first flat harnesses, each in which a plurality of first conductive wires are covered with a first insulating cover; and

a plurality of second flat harnesses, each in which a plurality of second conductive wires are covered with a second insulating cover, each of the second flat harnesses superposed on the first flat harnesses so as to intersect the first flat wire harnesses;

wherein each second conductive wire is welded to one of the first conductive wires of at least one first flat harness at least one of intersecting points of each second conductive wire and the first conductive wires, through the first insulating cover and the second insulating cover.

According to the present invention, there is also provided a method of manufacturing a wire harness, comprising the steps of:

preparing a first flat harness, in which a plurality of first conductive wires are covered with a first insulating cover;

preparing a second flat harness, in which a plurality of second conductive wires are covered with a second insulating cover,

superposing the second flat harness intersectingly on the first flat harness; and

welding each second conductive wire to one of the first conductive wires at one of intersecting points of each second conductive wire and the first conductive wires, through the first insulating cover and the second insulating cover.

In the above configuration, there is no need to prepare any special jig, so that the cost can be saved. And besides, since the conductive wires are covered with the insulating cover, there can be saved the time and labor for mounting the conductors one by one in jig exemplified in the related-art, thereby the operation efficiency can be improved.

Preferably, the wire harness further comprises a connector provided on at least one of both longitudinal ends of the second flat harness.

In this case, the second flat harness serves as a branch harness. Therefore, a connector connection between the branch harness and the other wire harness can be omitted.

Preferably, the welding step is performed by at least one of ultrasonic welding, laser beam welding and thermal welding.

In this case, the welding operation can be effected without the need for any special skill and technique.

Preferably, the first conductive wires and the second conductive wires are so welded that at least one of the first flat harness and the second flat harness is foldable.

In this case, the wire harness can be flexed in accordance with the wiring situation. For example, the flat harness can be mounted in a compact manner on the side wall face of the reinforce or the like.

According to the present invention, there is also provided a vehicle module assembly incorporating the wire harness.

In this case, the shortest wiring can be achieved in accordance with the car kind variation, so that the modularized design of various portions of the vehicle can be further improved.

### BRIEF DESCRIPTION OF THE DRAWINGS

The above objects and advantages of the present invention will become more apparent by describing in detail preferred exemplary embodiments thereof with reference to the accompanying drawings, wherein:

FIG. 1 is a perspective view of a vehicle module assembly;

FIG. 2 is a plan view showing a wiring circuitry according to a first embodiment of the invention;

FIG. 3 is a plan view showing a wiring circuitry according to a second embodiment of the invention;

FIG. 4 is a perspective view showing the wiring circuitry in which a part of a main flat harness is folded;

FIG. 5 is an enlarged perspective view of a jig for manufacturing the wiring circuitry;

FIG. 6 is a schematic plan view showing the arrangement of the jigs for manufacturing the wiring circuitry;

FIG. 7 is a perspective view of a welding machine used for manufacturing the wiring circuitry;

FIG. 8 is a system diagram of a positioning apparatus for manufacturing the wiring circuitry;

FIGS. 9A and 9B are views showing a method of manufacturing a related-art circuitry; and

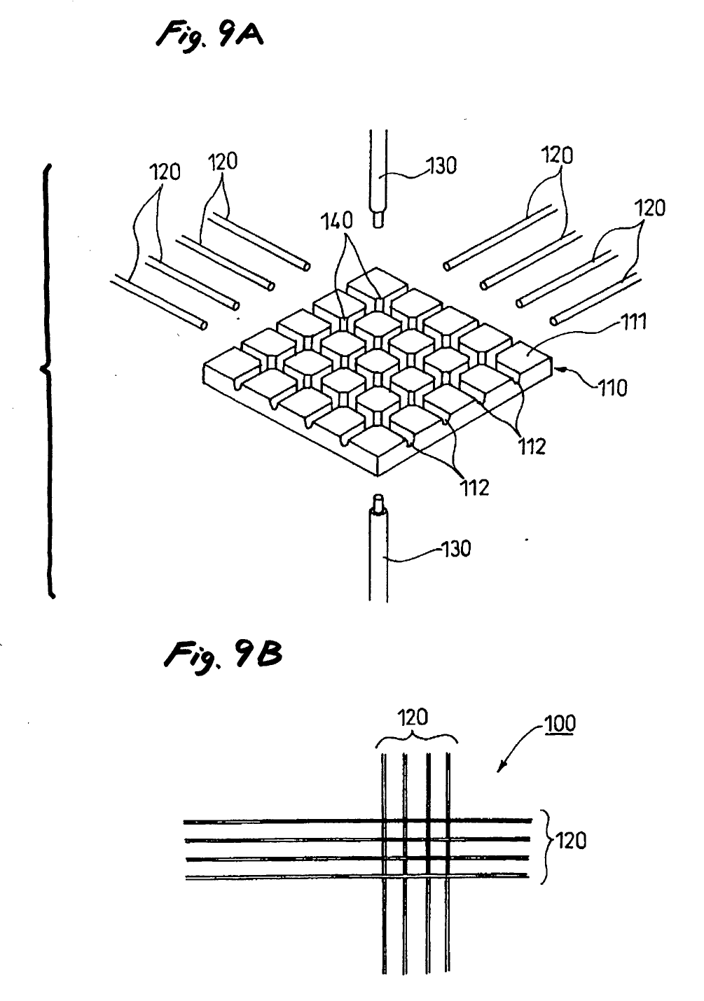

FIG. 10 is a perspective view of a related-art vehicle module assembly.

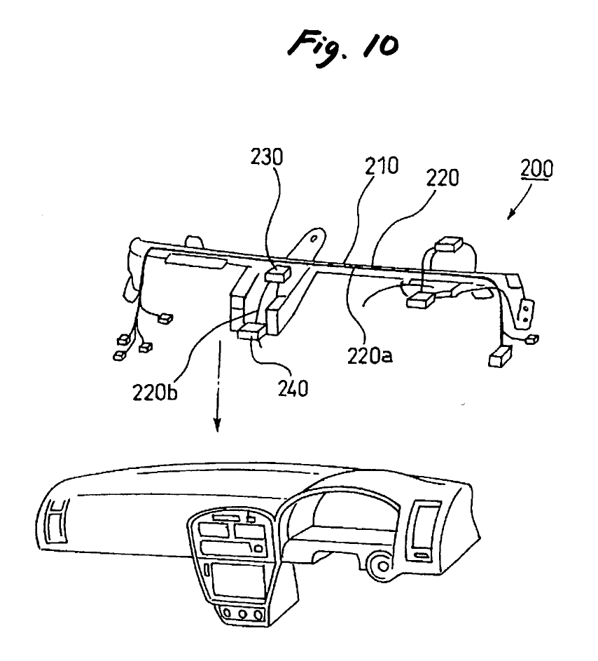

### DETAILED DESCRIPTION OF THE PREFERRED EMBODIMENTS

Preferred embodiments of a wire harness according to the present invention, as well as a vehicle module assembly incorporating wire harness, will now be described in detail with reference to the accompanying drawings.

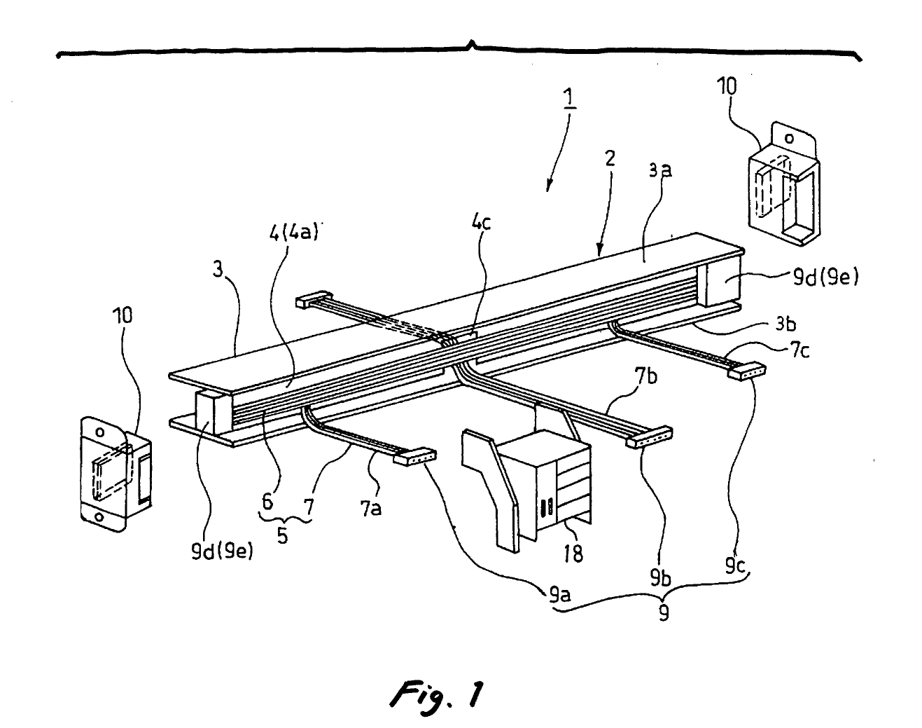

As shown in FIG. 1, a vehicle module assembly 1 comprises a combination of a modularized reinforce 2, a wire harness 5, and an electrical equipment 18. The reinforce 2 comprises a steel plate processed into an elongated member having an H-shaped cross section, and upper and lower faces 3a and 3b of a flange 3 are oriented horizontally, and a main flat harness 6, serving as a main bus of the wire harness 5, is fixedly mounted on one side face 4a of a web 4 by clips (not shown). Self-fitting connectors 9 are mounted respectively on distal ends of branch flat harnesses (branch wires) 7 branching off from the main flat harness 6.

The required number of branch flat harness 7 (7a, 7b and 7c) are provided for connection to various electrical equipments 18, and are joined to the main flat harness 6. The positions of joint of the branch flat harnesses 7 to the main flat harness 6 are predetermined by the reinforce 2 modularized in accordance with the car kind variation.

Electrical equipments 18 such as a multi-media type electrical equipment are attaches at predetermined positions provided on the main flat harness 6. The self-fitting connectors 9a, 9b and 9c of the branch flat harnesses 7a, 7b and 7c are connected to respective associated electrical equipments during this attaching process.

The main flat harness 6 extends between opposite (right and left) ends of the reinforce 2, and the opposite end portions thereof are so processed as to be connected to electric junction boxes, respectively.

The reinforce 2 is mounted on junction box brackets 10 which are provided respectively at opposite side portions of a vehicle body, and serve also as mounting portions for the reinforce 2. At this time, wire harnesses (not shown) on the vehicle body can be connected to the main flat harness 6 at the junction box brackets 10 in a one-touch manner.

A through hole 4c is formed through the web 4, and this through hole 4c is used when extending the branch flat harness 7b from the instrument panel to the vehicle body side (the engine room side). A plurality of such through holes 4c are provided regularly in accordance with the car kind variation.

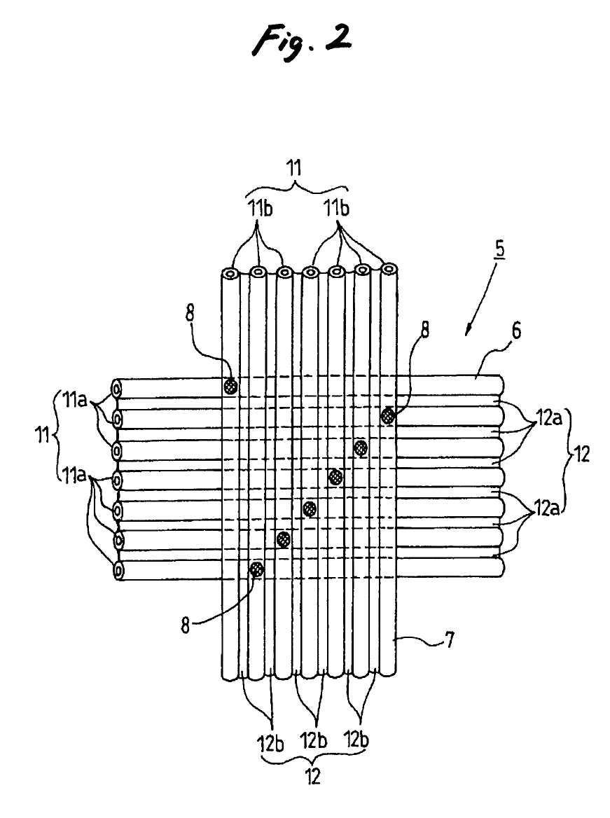

FIG. 2 shows a wiring circuitry according to a first embodiment. In the circuitry, a wire harness 5 comprises a main flat harness 6 and a branch flat harness 7 and (6a and 6b) which are arranged in a lattice-like manner. The branch flat harnesses and the main flat harnesses are joined at predetermined intersections 8 (indicated by black dots in the figure).

Each main flat harness 6, extending in the horizontal direction, comprises a plurality of parallel juxtaposed conductors 11a spaced at a predetermined pitch, and an insulating material 12a covering these conductors 11a, the insulating material 12a being a flexible material.

Similarly, each branch flat harness 7, extending in the vertical direction, comprises a plurality of parallel juxtaposed conductors 11b, spaced at a predetermined pitch, and an insulating material 12b covering these conductors 11b, the insulating material 12b being a flexible material.

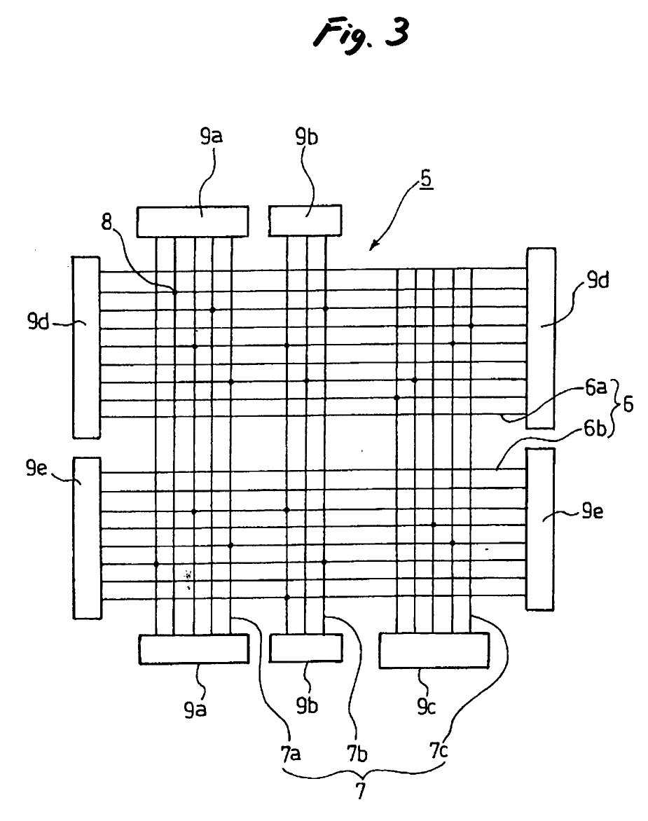

FIG. 3 shows a wiring circuitry according to a second embodiment. In the circuitry, three branch flat harnesses 7 (7a, 7b and 7c) and two main flat harnesses 6 (6a and 6b) which are arranged in a matrix-like manner. The branch flat harnesses and the main flat harnesses are joined at predetermined intersections 8 (indicated by black dots in the figure).

Reference numerals 9d and 9e denote movable-type multi-pole connectors.

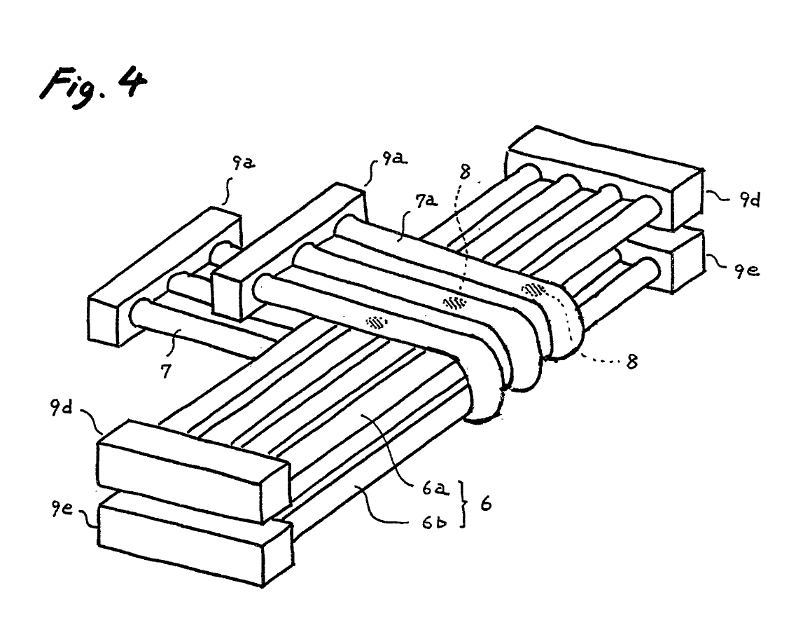

Since the insulating material 12a is flexible, at least one of the main flat harnesses 6 and the branch flat harnesses 7 can be folded as shown in FIG. 4 in accordance with the required wiring situation. In this figure, the branch flat harness 7a is folded to bundle the main flat harnesses 6a and 6b. For the better understanding, only the branch flat harness 7a among the branch flat harnesses 7a, 7b and 7c is depicted.

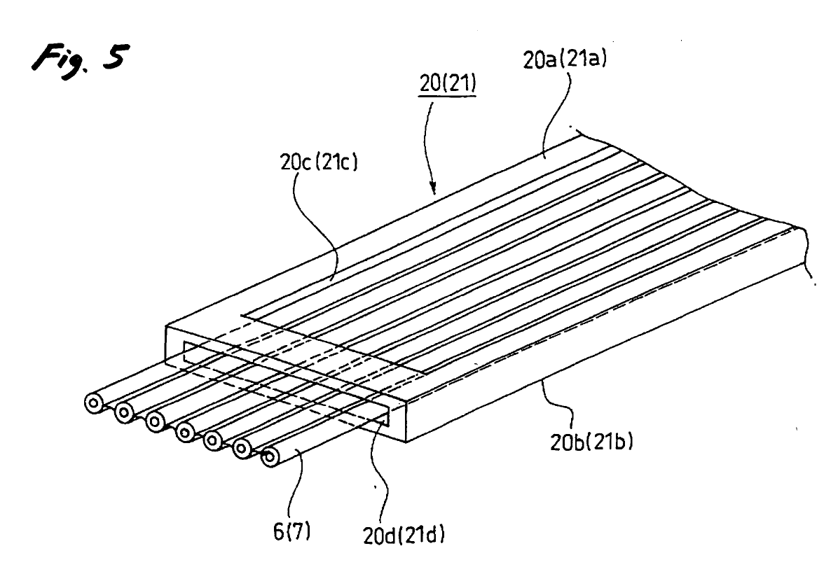

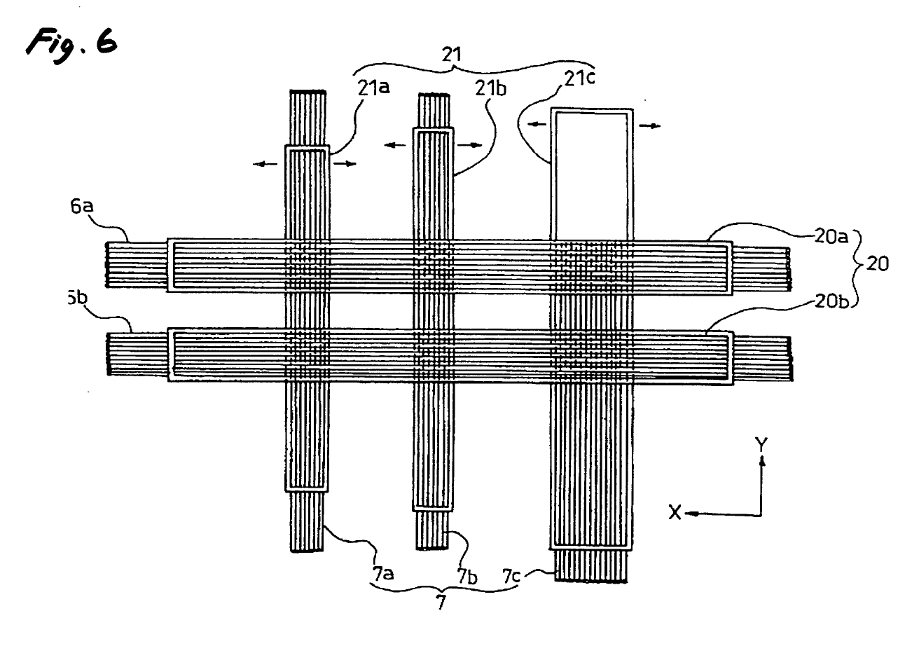

FIGS. 5 and 6 shows a jig 20 for the main flat harness 6 and a jig 21 for the branch flat harness 21 which are used for manufacturing the wiring circuitry.

As shown in FIG. 5, the jig 20 (which is similar to the jig 21 as shown in the figure) comprises a box-like member formed by hollowing out a long steel stock, and longitudinal openings 20c (21c) are formed respectively in upper and lower faces 20a and 20b (21a and 21b) thereof, and passage ports 20d (21d) are formed in opposite longitudinal ends thereof, respectively.

The passage port 20d (21d) serves as an opening, through which the main flat harness 6 (the branch flat harness 7) is led out from the jig 20 (21), and also serves as an entry port for a torch of a welding machine (described later).

On the other hand, the passage ports 20d (21d) serve as guide members for the insertion of the main flat harness 6 (the branch flat harness 7), and enable the welding machine to positively effect the joining operation, and also serve to prevent the flat harness 6 (7) in the matrix from meandering and rising halfway.

In order to more positively prevent such meandering and halfway-rising, clip devices (not shown) may be provided adjacent respectively to the passage ports 20d (21d) so as to support the flat harness 6 (7) so that the flat harness 6 (7) can be made tense within the passage ports 20d (21d) provided respectively at the opposite ends of the jig.

FIG. 6 corresponds to FIG. 3, and the jigs 20 for the main flat harnesses 6 are fixed to a square frame (not shown), while the jigs 21 for the branch flat harnesses 7 are movable in a direction of an X-axis of coordinates in this figure.

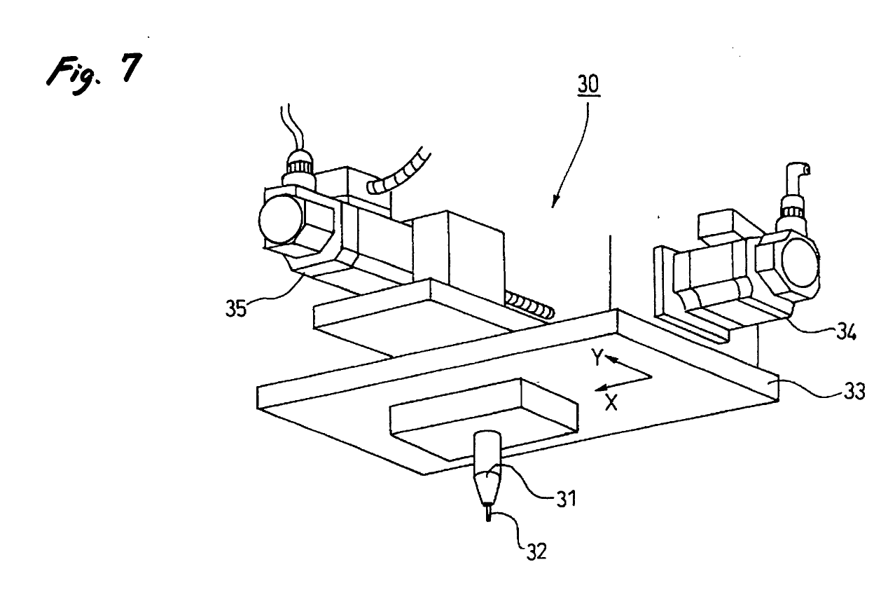

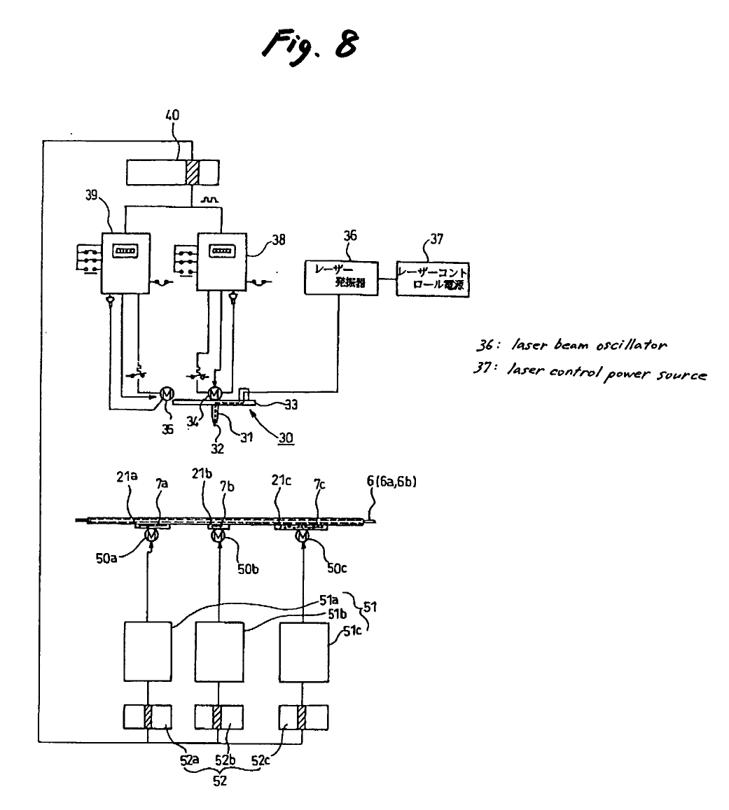

FIG. 7 is a perspective view of the welding machine 30 for joining the conductors 11a and 11b of the main and branch flat harnesses 6 and 7, and FIG. 8 is a schematic diagram of a system for driving the welding machine 30 and the jigs 20 (21) simultaneously and relative to each other so as to effect the working.

In the welding machine 30, the laser torch 31 for effecting the laser beam welding is fixedly mounted on and extends downwardly from a lower face of a movable X-Y table 33. An X-axis direction servomotor 34 and a Y-axis direction servomotor 35, which provide a drive system, are mounted on the movable X-Y table 33, and with these servomotors, a nozzle 32 of the laser torch 32 can be located sequentially at the intersections of the conductors 11a and 11b of the main and branch flat wire harnesses 6 and 7 (at each of which the conductors 11a and 11b are to be joined together) in coordinate relation to the movement of the jig 20 (21).

A control system for driving the movable X-Y table 33 includes a laser beam oscillator 36 for emitting a laser beam, and a laser control power source 37 for supplying electric power to the laser beam oscillator 36.

With respect to a control system for driving the X-axis direction servomotor 34 and the Y-axis direction servomotor 35, an X-axis servo-amplifier 38 and a Y-axis servo-amplifier 39 are connected to the X-axis direction servomotor 34 and the Y-axis direction servomotor 35, respectively, and the X-axis servo-amplifier 38 and the Y-axis servo-amplifier 39 are connected to a computer 40. These amplifiers transmit a position signal, fed thereto from the computer 40, so as to drive the X-axis direction servomotor 34 and the Y-axis direction servomotor 35 so that the nozzle 32 of the laser torch 31 can be moved into the intersection of the predetermined conductors 11a and 11b. In this manner, the microcomputer control is effected.

On the other hand, servomotors 50 (50a, 50b and 50c), servo-amplifiers 51 (51a, 51b and 51c) and computers 52 (52a, 52b and 52c) are provided at the jigs 20 (21) in order to move the jigs in coordinate relation to the movement of the laser torch 31.

The computer 40 and the computers 52 (52a, 52b and 52c) are beforehand so set that when the position signal is inputted into the computer 40, the computers 52 (52a, 52b and 52c) compute this position signal so as to bring the intersection of the conductors 11a and 11b of the main and branch flat harnesses 6 and 7 (which are to be joined together) into vertical registry with the nozzle 32 of the laser torch 31.

Each servo system can effect the two-axis linear interpolation in combination with the computer, and can effect the high-speed, high-precision positioning.

In this embodiment, although the laser beam welding machine, which can suppress the scattering of sputter, is used as the welding machine 30, the welding machine is not limited to it, but an ultrasonic welding machine or a thermal welding machine may be used.

A method of producing the above wire harness 5 will be briefly described, and then a method of using it will be described.

First, the main flat harnesses 6 are passed respectively through the jigs 20, and the branch flat harnesses 7 are passed respectively through the jigs 21, thus effecting the presetting operation.

Then, electric power is supplied, and the necessary positioning information is inputted into the computer 40 and the computers 52 (52a, 52b and 52c). The essential input information includes the information relating a reference position on the X-axis relative to the origin of the coordinates and a move amount in the X-axis direction thereof. Since the position of each branch flat harness 7 relative to the main flat harnesses 6 is determined in accordance with the car kind variation, the above information is set in accordance with the variation.

Namely, the modularized wire harness 5 is obtained by the above information. Then, the X-Y table 33 is moved to the intersection of the conductors 11a and 11b to be connected together.

Then, a work table (not shown), supporting the harness fixing jigs 20 and 21, ascends, so that the conductors 11a and 11b are pressed into contact with the nozzle 32 at their intersection, and after this is confirmed, the conductors 11a and 11b are welded together at their intersection by a laser beam. This welding operation is effected sequentially at the other intersections of the conductors 11a and 11b to be connected.

When all of the required welding operations are thus completed, the movable X-Y table 33 is returned to its initial position, and the work table is also returned to its initial position.

The main and branch flat harnesses 6 and 7, thus welded together, are removed from their respective harness fixing jigs 20 and 21 through the opening 20a and 21a. The predetermined connectors are attached to the ends of each of the main and branch flat harnesses 6 and 7, respectively, thus providing the desired wire harness 5.

The suitable output of the laser beam oscillator 36 for effecting the welding is 20 to 50 [J].

In the above operation process, the operation for mounting the conductors 11a and 11b one by one in the jigs can be omitted, and besides the conductors 11a and 11b to be connected together can be automatically connected together by welding.

The thus prepared wire harness 5 is fixed to the one side face 4a of the web 4 of the reinforce 2 by the clips (not shown). Then, the electrical equipments 18, a center brace and so on are mounted respectively on predetermined portions of the reinforce 2, thereby forming a sub-assembly.

Then, the reinforce 2 is mounted on the instrument panel body having meter-indicating portions and switch-indicating portions mounted thereon. In this manner, the instrument panel module is formed.

The junction box brackets 10, serving also as the mounting portions for mounting on the vehicle body, are beforehand fixedly secured to this vehicle body by welding or by screws. The junction box brackets 10 have grooves for fitting on the opposite end portions of the flange portions 2a and 2b of the reinforce 2.

The instrument panel module is fitted in these grooves, and by doing so, this module is mounted on the vehicle body.

The multi-pole connectors 9d (9e), provided respectively at the opposite ends of each main flat harness 6, are connected to the wire harnesses, installed on the vehicle body, at the electric junction box brackets 10 in a one-touch manner by self-fitting connection.

As described above, the wire harness 5 is incorporated in the reinforce 2 forming the vehicle module assembly, and by doing so, the electric wiring in the vehicle module assembly can be provided in a labor-saving manner, and the efficiency of the operation can be enhanced.

Although the present invention has been shown and described with reference to specific preferred embodiments, various changes and modifications will be apparent to those skilled in the art from the teachings herein. Such changes and modifications as are obvious are deemed to come within the spirit, scope and contemplation of the invention as defined in the appended claims.

What is claimed is:

1. A wire harness, comprising:
a first flat harness, in which a plurality of first conductive wires are covered with a first insulating cover; and
a second flat harness, in which a plurality of second conductive wires are covered with a second insulating cover, the second flat harness being intersectingly superposed on the first flat harness,
wherein each second conductive wire is welded to one of the first conductive wires at one of intersecting points of each second conductive wire and the first conductive wires, through the first insulating cover and the second insulating cover.

2. The wire harness as set forth in claim 1, further comprising a connector provided on at least one of both longitudinal ends of the second flat harness.

3. The wire harness as set forth in claim 1, wherein the first conductive wires and the second conductive wires are so welded that at least one of the first flat harness and the second flat harness is foldable.

4. A wire harness, comprising:
a plurality of first flat harnesses, each in which a plurality of first conductive wires are covered with a first insulating cover; and
a plurality of second flat harnesses, each in which a plurality of second conductive wires are covered with a second insulating cover, each of the second flat harnesses superposed on the first flat harnesses so as to intersect the first flat wire harnesses;
wherein each second conductive wire is welded to one of the first conductive wires of at least one first flat harness at least one of intersecting points of each second conductive wire and the first conductive wires, through the first insulating cover and the second insulating cover.

5. A vehicle module assembly incorporating the wire harness as set forth in any one of claims 1 to 4.

6. A method of manufacturing a wire harness, comprising the steps of:
preparing a first flat harness, in which a plurality of first conductive wires are covered with a first insulating cover;
preparing a second flat harness, in which a plurality of second conductive wires are covered with a second insulating cover,
superposing the second flat harness intersectingly on the first flat harness; and
welding each second conductive wire to one of the first conductive wires at one of intersecting points of each second conductive wire and the first conductive wires, through the first insulating cover and the second insulating cover.

7. The manufacturing method as set forth in claim 6, wherein the welding step is performed by at least one of ultrasonic welding, laser beam welding and thermal welding.
